(19) United States
(12) Patent Application Publication
(10) Pub. No.: US 2025/0263257 A1
(43) Pub. Date: Aug. 21, 2025

(54) TRANSPORT DEVICE AND IMAGE FORMING APPARATUS

(71) Applicant: FUJIFILM Business Innovation Corp., Tokyo (JP)

(72) Inventors: Ryosuke YAMAJI, Kanagawa (JP); Hiroyuki TAMAI, Kanagawa (JP); Ryuga OISHI, Kanagawa (JP)

(73) Assignee: FUJIFILM Business Innovation Corp., Tokyo (JP)

(21) Appl. No.: 18/785,923

(22) Filed: Jul. 26, 2024

(30) Foreign Application Priority Data
Feb. 16, 2024 (JP) 2024-022384

(51) Int. Cl. B65H 5/06; G03G 15/00

(52) U.S. Cl. CPC B65H 5/062; G03G 15/6529; B65H 2404/144

(57) ABSTRACT

A transport device includes a shaft body provided with a transport member configured to transport a medium, the shaft body extending in a first direction intersecting a transport direction in which the medium is to be transported, the shaft body being rotatably supported; an urging part configured to apply a nipping pressure to the transport member by urging the shaft body from an outer peripheral side of the shaft body; and a movable part supported independently of the shaft body and configured to move the urging part away from the shaft body by moving in the first direction in such a manner as to go into a gap between the shaft body and the urging part.

### CROSS-REFERENCE TO RELATED APPLICATIONS

This application is based on and claims priority under 35 USC 119 from Japanese Patent Application No. 2024-022384 filed Feb. 16, 2024.

### BACKGROUND

### (i) Technical Field

The present disclosure relates to a transport device and an image forming apparatus.

### (ii) Related Art

A sheet transport device disclosed in Japanese Unexamined Patent Application Publication No. 2011-136808 includes a transport-roller pair, a pressure arm, first and second urging-force-applying members, and an adjusting drive unit. The transport-roller pair includes a driving roller to which a driving force is transmitted, and a driven roller that is pressed against the driving roller. The pressure arm includes first and second arms provided across a pivot from each other. The pressure arm rotatably supports the driven roller at the distal end of the first arm thereof. The second arm has first and second acting points that are defined at different distances from the pivot. The first and second urging-force-applying members are configured to apply respective urging forces to the first and second acting points defined on the pressure arm. The adjusting drive unit is configured to selectively change the operating lengths of the first and second urging-force-applying members to adjust the pressing force with which the driven roller is pressed against the driving roller. In the adjustment, the adjusting drive unit increases the urging force exerted by one of the first and second urging-force-applying members and decreases the urging force exerted by the other of the first and second urging-force-applying members.

### SUMMARY

Aspects of non-limiting embodiments of the present disclosure relate to a configuration in which a nipping pressure is applied to a transport member by causing an urging part to urge a shaft body and that has a smaller overall size than a configuration in which the nipping pressure is adjusted by moving, in the radial direction of the shaft body, a supporting member that supports the urging part in the radial direction of the shaft body.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a transport device including a shaft body provided with a transport member configured to transport a medium, the shaft body extending in a first direction intersecting a transport direction in which the medium is to be transported, the shaft body being rotatably supported; an urging part configured to apply a nipping pressure to the transport member by urging the shaft body from an outer peripheral side of the shaft body; and a movable part supported independently of the shaft body and configured to move the urging part away from the shaft body by moving in the first direction in such a manner as to go into a gap between the shaft body and the urging part.

### BRIEF DESCRIPTION OF THE DRAWINGS

Exemplary embodiments of the present disclosure will be described in detail based on the following figures, wherein:

FIG. 1 is a schematic diagram of an image forming apparatus according to an exemplary embodiment;

FIG. 2A is a plan view of a transport device included in the image forming apparatus according to the exemplary embodiment;

FIG. 2B is a side view of the transport device;

FIG. 3 is a sectional view of the transport device illustrated in FIG. 2B, taken along line III-III;

FIG. 4A is a plan view of a part of the transport device according to the exemplary embodiment, with a handle being in contact with a front wall of an intermediate bracket;

FIG. 4B is a side view of the part illustrated in FIG. 4A;

FIG. 5 is a plan view of the part illustrated in FIG. 4A, with an intermediate spring removed;

FIG. 6 is a sectional side view of a part of the transport device according to the exemplary embodiment, illustrating a bearing and relevant elements therearound;

FIG. 7A is a plan view of a part of the transport device according to the exemplary embodiment, with an assist member being in contact with a rear wall of the intermediate bracket;

FIG. 7B is a side view of the part illustrated in FIG. 7A; and

FIG. 8A is a plan view of a part of a transport device according to a modification of the exemplary embodiment; and

FIG. 8B is a side view of the part illustrated in FIG. 8A.

### DETAILED DESCRIPTION

### Exemplary Embodiment

A transport device and an image forming apparatus according to an exemplary embodiment of the present disclosure will be now described with reference to the drawings. In the drawings, arrow H represents the top-bottom direction of the image forming apparatus, arrow W represents the widthwise direction of the image forming apparatus, arrow DR represents the rear side of the image forming apparatus in the front-rear direction, and arrow DF represents the front side of the image forming apparatus in the front-rear direction. The top-bottom direction of the image forming apparatus, the widthwise direction of the image forming apparatus, and the front-rear direction of the image forming apparatus are orthogonal to each other. These directions are defined for convenience of description and do not limit the configuration of the image forming apparatus. In describing these directions of the image forming apparatus, the phrase “of the image forming apparatus” may be omitted. The front-rear direction is an exemplary first direction.

### Image Forming Apparatus

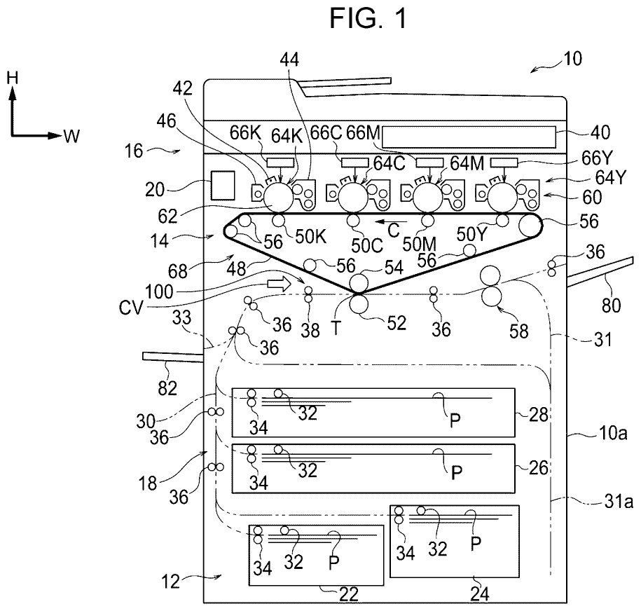

An image forming apparatus 10 is configured to form an image on a sheet member P. The sheet member P is an exemplary medium. As illustrated in FIG. 1, the image forming apparatus 10 includes relevant elements provided inside an apparatus body 10a. The image forming apparatus 10 basically includes a sheet container section 12, a main operation section 14, and a transport section 18. The image forming apparatus 10 further includes a display part 40, which serves as an interface through which the user exchanges information with the image forming apparatus 10.

### Sheet Container Section

As illustrated in FIG. 1, the sheet container section 12 is configured to contain sheet members P. The sheet container section 12 includes a first container 22, a second container 24, a third container 26, and a fourth container 28. The first container 22, the second container 24, the third container 26, and the fourth container 28 contain sheet members P of different sizes as appropriate. The first container 22, the second container 24, the third container 26, and the fourth container 28 are each provided with a feed roll 32 and a double-feed-preventing roll 34. The feed roll 32 is configured to feed the sheet members P, contained as above, one by one in response to an instruction issued by a managing unit 20, which is configured to manage the operations of relevant elements. The double-feed-preventing roll 34 is configured to transport the sheet member P fed from the feed roll 32 to a transport path 30, which runs inside the image forming apparatus 10.

### Main Operation Section

As illustrated in FIG. 1, the main operation section 14 is configured to visualize, on the sheet member P transported from the sheet container section 12, image data generated from an original by an image reading section 16 or image data received from an external device. The main operation section 14 includes an image forming unit 60, a transfer unit 68, and a fixing device 58.

The image forming unit 60 is configured to form a toner image. The image forming unit 60 includes image forming subunits 64K, 64C, 64M, and 64Y, which are configured to form toner images in respective colors of black (K), cyan (C), magenta (M), and yellow (Y). In the following description, suffixes K, C, M, or Y added to a corresponding one of the reference signs may be omitted unless otherwise distinguished.

The image forming subunits 64 include respective photoconductor drums 62, respective charging devices 42, respective developing devices 44, respective cleaning members 46, and respective exposure devices 66 (66K, 66C, 66M, and 66Y). The charging devices 42 are configured to charge the respective photoconductor drums 62 while the photoconductor drums 62 are rotating. The exposure devices 66 are configured to emit exposure light to the respective charged photoconductor drums 62, thereby forming respective electrostatic latent images on the photoconductor drums 62. The developing devices 44 are configured to develop the respective electrostatic latent images into toner images. That is, the image forming apparatus 10 according to the present exemplary embodiment is an electrophotographic apparatus.

The transfer unit 68 is configured to transfer the toner images onto the sheet member P. As illustrated in FIG. 1, the transfer unit 68 is located below the image forming unit 60. The transfer unit 68 includes a transfer belt 48, first transfer rolls 50, a second transfer roll 52, an assist roll 54, and rolls 56.

The transfer belt 48 has an endless shape and is positioned to form a triangular shape with the top thereof pointing downward as viewed from the front in the front-rear direction. The transfer belt 48 is in contact with the image forming unit 60 from below in the top-bottom direction.

The first transfer rolls 50 (50K, 50C, 50M, and 50Y) each have a cylindrical shape extending in the front-rear direction. The first transfer rolls 50 are arranged in correspondence with the photoconductor drums 62 and nip the transfer belt 48 in cooperation with the respective photoconductor drums 62, so that the toner images are to be transferred from the photoconductor drums 62 collectively onto the transfer belt 48.

The second transfer roll 52 has a cylindrical shape extending in the front-rear direction and is located below the first transfer rolls 50. The second transfer roll 52 is configured to transfer the set of toner images from the transfer belt 48 to the sheet member P at a second transfer position T.

The assist roll 54 has a cylindrical shape extending in the front-rear direction and is located on the inner side of the transfer belt 48, at a position across the transfer belt 48 from the second transfer roll 52.

The rolls 56 are located on the inner side of the transfer belt 48. The transfer belt 48 is wound around the rolls 56. One of the rolls 56 serves as a driving roll configured to cause the transfer belt 48 to rotate in a direction represented by arrow C in FIG. 1.

The fixing device 58 has a cylindrical shape extending in the front-rear direction and is located downstream of the second transfer position T. The fixing device 58 is configured to fix the set of toner images transferred onto the sheet member P to the sheet member P.

### Transport Section

As illustrated in FIG. 1, the transport section 18 is configured to receive the sheet member P transported from the double-feed-preventing roll 34 or fed from the outside of the apparatus body 10a, and to transport the sheet member P. The transport section 18 includes the transport path 30, transport rolls 36, and a transport device 38.

The transport path 30 defines the direction in which the sheet member P is to be transported (hereinafter simply referred to as “transport direction CV”). The transport direction CV intersects the front-rear direction but does not necessarily coincide with the widthwise direction.

An upstream portion of the transport path 30 extends upward from a lower position on one side in the widthwise direction. A manual feed path 33 is connected to the upper end of the upstream portion of the transport path 30.

A downstream portion of the transport path 30 extends in the widthwise direction from the one side to the other side and is connected to an output part 80, where the sheet member P is to be outputted to the outside of the apparatus body 10a. The downstream end of the transport path 30 is connected to a duplex transport path 31, in which the sheet member P is transported to be turned over for the formation of another image on the back side of the sheet member P. The duplex transport path 31 includes a switchback path 31a. In the duplex transport path 31, the sheet member P fed from the switchback path 31a is turned upside down and is fed to the upper end of the upstream portion, in the transport direction CV, of the transport path 30.

The transport rolls 36 each have a cylindrical shape extending in the front-rear direction and are arranged along the transport path 30. The transport rolls 36 each include a pair of rolls that are located across the transport path 30 from each other in the apparatus body 10a.

The transport device 38 is located upstream of the second transfer position T in the transport direction CV. The transport device 38 is configured to temporarily stop the sheet member P and to feed the sheet member P to the second transfer position T at a determined timing. The transport device 38 has three functions: a basic function, a nipping-pressure-applying function, and a nipping-pressure-adjusting function. The functions of the transport device 38 will now be described.

### Basic Function

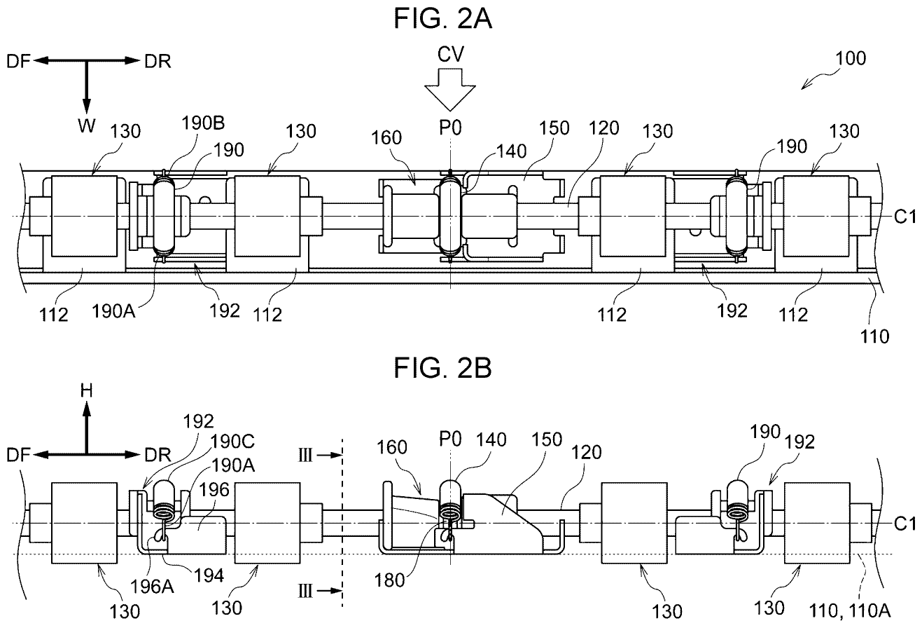

As illustrated in FIGS. 2A and 2B, the transport device 38 includes a guide 110, a shaft 120, and transport-roll pairs 130, all of which are configured to exert the basic function.

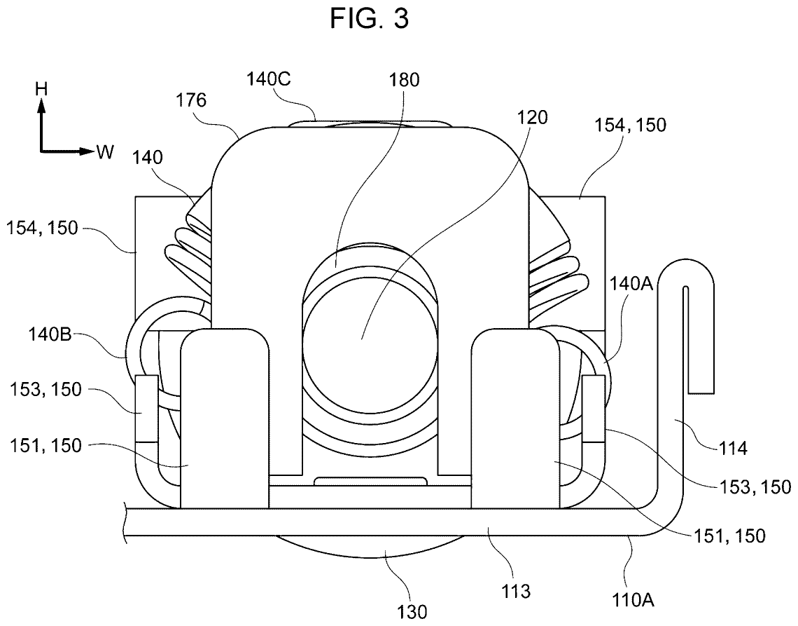

As illustrated in FIGS. 2A, 2B, and 3, the guide 110 is an elongated plate member extending in the front-rear direction and includes a bottom part 113 and an upright part 114. The bottom part 113 extends in the widthwise direction, and the upright part 114 extends upward in the top-bottom direction from the bottom part 113. Hence, the guide 110 has an L shape in sectional view. The guide 110 is supported by a frame (not illustrated) included in the apparatus body 10a. As illustrated in FIG. 2A, the guide 110 has holes 112, which are provided in the bottom part 113 and are at intervals from each other in the front-rear direction. In the present exemplary embodiment, the guide 110 has four holes 112. The guide 110 is configured to guide the sheet member P by the bottom part 113 in such a manner as to orient the sheet member P in the transport direction CV.

As illustrated in FIG. 2A, the shaft 120 extends in the front-rear direction with a center axis C1, and is rotatably supported by the guide 110. The shaft 120 is an exemplary shaft body. As illustrated in FIG. 2B, the shaft 120 is located above the guide 110.

As illustrated in FIGS. 2A and 2B, the transport-roll pairs 130 are pairs of cylindrical rolls each extending in the front-rear direction. The rolls in each pair are arranged one above the other. The transport-roll pairs 130 are each an exemplary transport member. In each of the transport-roll pairs 130, the upper one of the rolls that is located on the upper side in the top-bottom direction is supported by the shaft 120, and the lower one (see FIG. 1) of the rolls that is located on the lower side in the top-bottom direction is supported by the guide 110. The transport-roll pairs 130 are located in correspondence with the holes 112. The transport-roll pairs 130 are configured to transport the sheet member P in the transport direction CV, with a portion of the peripheral surface of each of the upper rolls being exposed in a corresponding one of the holes 112 and projecting downward relative to the lower surface, 110A, of the guide 110 in such a manner as to be pressed against a corresponding one of the lower rolls under the nipping-pressure-applying function. In the present exemplary embodiment, four transport-roll pairs 130 are provided in correspondence with the four holes 112.

### Application of Nipping Pressure

The transport device 38 includes a bearing 180, end-side springs 190, an intermediate spring 140, end-side brackets 192, and an intermediate bracket 150, all of which are configured to exert the nipping-pressure-applying function. The end-side springs 190 and the intermediate spring 140 are to apply nipping pressure to the transport-roll pairs 130 through the shaft 120.

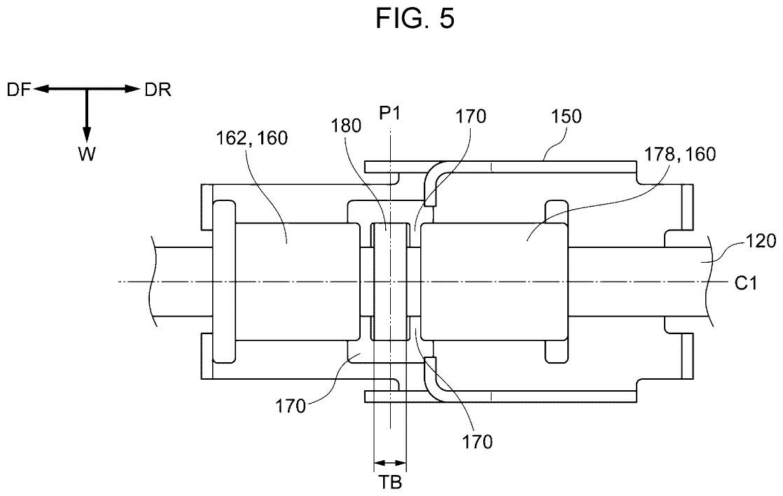

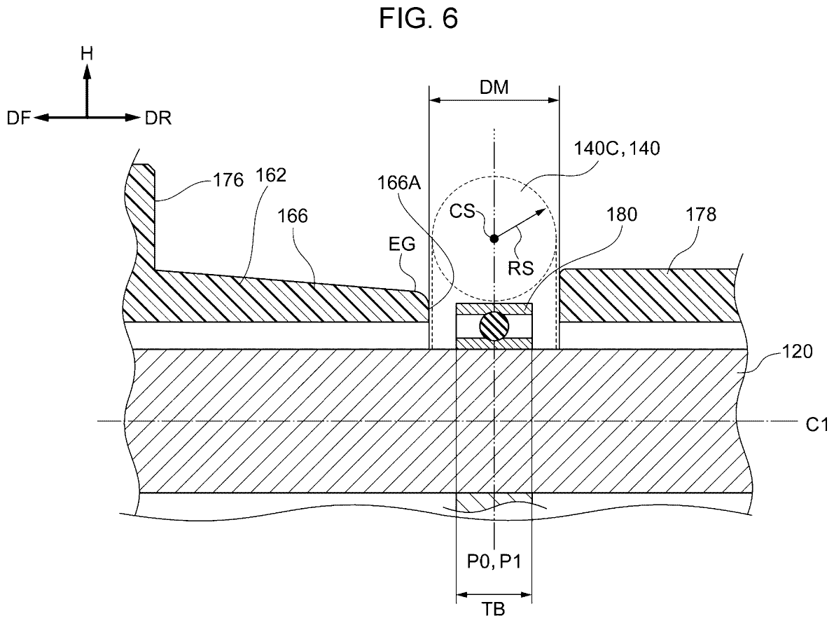

As illustrated in FIG. 5, the bearing 180 is located on the outer peripheral side of the shaft 120 and has a circular shape when viewed from the front in the front-rear direction. The bearing 180 is an exemplary receiving part. In the present exemplary embodiment, the bearing 180 is an antifriction bearing. The bearing 180 is to reduce the rotational resistance in an area where a relatively high nipping pressure is to be applied. The length (thickness) of the bearing 180 in the front-rear direction is denoted by TB (see FIG. 6).

As illustrated in FIGS. 2A and 2B, the end-side springs 190 are provided near the two respective ends of the shaft 120 in the front-rear direction. In the present exemplary embodiment, the end-side springs 190 are each a helical extension spring. As illustrated in FIG. 2B, the end-side springs 190 each include a central portion 190C, and one end 190A and an other end 190B. The central portion 190C is bent in a U shape in such a manner as to cover an upper portion of the shaft 120 in the top-bottom direction. The ends 190A and 190B are positioned on the two respective sides of the shaft 120 in the transport direction CV. The end-side springs 190 urge the shaft 120 from the outer peripheral side while being supported by the respective end-side brackets 192 as to be described below.

As illustrated in FIG. 3, the intermediate spring 140 includes a central portion 140C, and one end 140A and an other end 140B. The central portion 140C is bent in a U shape in such a manner as to cover an upper portion of the shaft 120 in the top-bottom direction. The ends 140A and 140B are positioned on the two respective sides of the shaft 120. Thus, the intermediate spring 140 urges the shaft 120 from the outer peripheral side.

As illustrated in FIGS. 2A and 2B, the intermediate spring 140 is provided at an intermediate position that is between the two end-side springs 190 in the front-rear direction and where none of the holes 112 are provided. In the present exemplary embodiment, the intermediate spring 140 is a helical extension spring. The intermediate spring 140 is an exemplary urging part.

Referring to FIG. 6, in a section taken along the center axis C1 of the shaft 120, the central portion 140C of the intermediate spring 140 has a circular shape having a center CS and a radius RS to the outer periphery. Twice the radius RS of the intermediate spring 140 (i.e., the diameter of the intermediate spring 140) is longer than the length TB of the bearing 180 in the front-rear direction.

The intermediate spring 140 has a greater elastic modulus than the end-side springs 190. The intermediate spring 140 urges the shaft 120 more strongly than the end-side springs 190. The intermediate spring 140 urges the shaft 120 through the bearing 180 while being supported by the intermediate bracket 150 as to be described below.

As illustrated in FIGS. 2A and 2B, the end-side brackets 192 each include a plate-like body 194, which extends along the guide 110; and a pair of side walls 196, which extend upward from the two respective widthwise ends of the body 194. Hence, the end-side brackets 192 each have a U shape that is open upward when viewed in the front-rear direction. The end-side brackets 192 are fixed to the guide 110. The side walls 196 each have a hook 196A, which is provided on the front side or the rear side in the front-rear direction.

The end-side brackets 192 are provided near the two respective ends of the shaft 120. Specifically, the end-side brackets 192 are provided at the following locations: between two of the transport-roll pairs 130 that are located on the front side in the front-rear direction, and between the other two transport-roll pairs 130 located on the rear side in the front-rear direction. The end-side brackets 192 are fixed to and supported by an upper portion of the shaft 120 in the top-bottom direction. The hooks 196A of each of the end-side brackets 192 support the two respective ends of a corresponding one of the end-side springs 190 such that the end-side bracket 192 is pressed against the shaft 120 from the upper side in the top-bottom direction. That is, the end-side springs 190 urge the shaft 120 by the central portions 190C thereof while being supported by the respective end-side brackets 192.

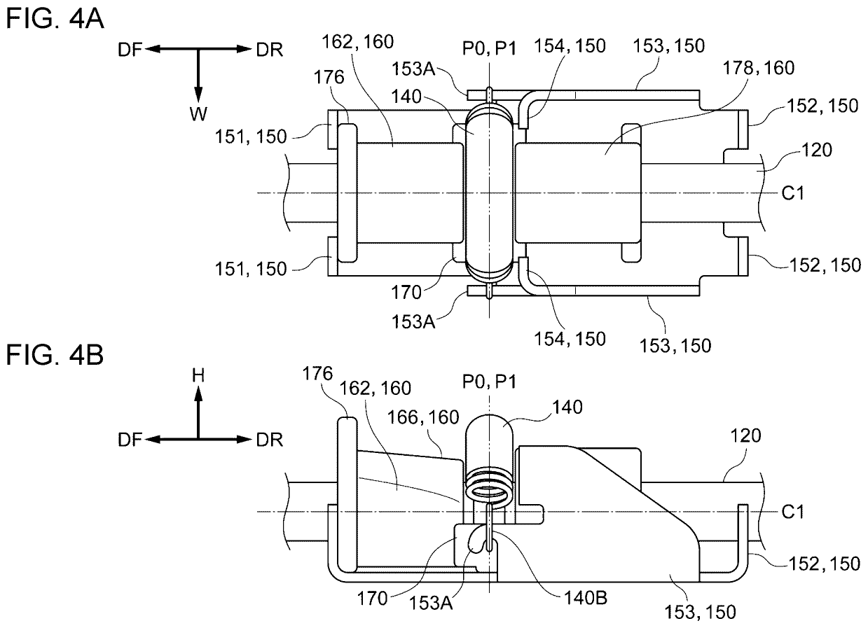

As illustrated in FIGS. 4A and 4B, the intermediate bracket 150 includes a front wall 151, a rear wall 152, side walls 153, and folds 154. The intermediate bracket 150 is located at an intermediate position between the two end-side brackets 192 in the front-rear direction and between the shaft 120 and the guide 110 in the top-bottom direction.

As illustrated in FIG. 3, the front wall 151 stands upward on the front side of the intermediate bracket 150 in the front-rear direction. The front wall 151 includes a pair of walls that are spaced apart from each other in the widthwise direction with the shaft 120 interposed therebetween.

As illustrated in FIGS. 4A and 4B, the rear wall 152 stands upward on the rear side of the intermediate bracket 150 in the front-rear direction. The rear wall 152 includes a pair of walls that are spaced apart from each other in the widthwise direction with the shaft 120 interposed therebetween.

As illustrated in FIGS. 4A and 4B, the side walls 153 are a pair of walls that each extend in the front-rear direction and stand upward in the top-bottom direction. The side walls 153 are spaced apart from each other in the widthwise direction with the shaft 120 interposed therebetween. The side walls 153 are higher than the front wall 151 and the rear wall 152. The side walls 153 include respective hooks 153A at the front ends thereof in the front-rear direction. The hooks 153A support the respective ends of the intermediate spring 140 at a position P0, which is defined in the front-rear direction. Thus, the intermediate spring 140 supported by the side walls 153 urges the shaft 120 by the central portion 140C thereof. The position P0 is the absolute position of the guide 110 and the intermediate bracket 150 in the apparatus body 10a. That is, the guide 110 and the intermediate bracket 150 are fixed to the apparatus body 10a.

As illustrated in FIGS. 4A and 4B, the folds 154 are projections located above the respective hooks 153A in the top-bottom direction and are obtained by folding respective front end portions, in the front-rear direction, of the side walls 153 toward the shaft 120. The folds 154 are located on the rear side relative to the intermediate spring 140 in the front-rear direction and closer to the respective ends 140A and 140B of the intermediate spring 140 than to the central portion 140C in the transport direction CV. The folds 154 prevent the intermediate spring 140 from deforming rearward in the front-rear direction. As illustrated in FIG. 3, the folds 154 are located above the center axis C1 of the shaft 120 in the top-bottom direction.

The above configuration exerts a nipping pressure to be applied to the transport-roll pairs 130.

### Adjustment of Nipping Pressure

The transport device 38 includes a nipping-pressure-adjusting mechanism 100, which is configured to exert the nipping-pressure-adjusting function. The nipping-pressure-adjusting mechanism 100 includes a structure in which the bearing 180 is supported in such a manner as to be slidable relative to the shaft 120, and a structure in which a movable part 160 is provided in such a manner as to be slidable relative to the shaft 120.

The bearing 180 is slidable (reciprocatable) in the front-rear direction on the outer peripheral side of the shaft 120, for adjusting the nipping pressure. Specifically, the inside diameter of the inner ring of the bearing 180 is slightly smaller than the outside diameter of the shaft 120, and the shaft 120 is inserted into the inner ring, so that the bearing 180 is slidable on the shaft 120. As illustrated in FIG. 5, the position of the bearing 180 in the front-rear direction of the shaft 120 is denoted by P1. That is, the position P1 is the reference position of the bearing 180 relative to the shaft 120. The position P1 is an exemplary first position.

Herein, adjustment refers to switching between a state where the intermediate spring 140 is effective on the shaft 120 and a state where the intermediate spring is not effective on the shaft 120. The way of adjusting the nipping pressure is automatically determined by the relationship between the position P1 of the bearing 180 and the position P0.

Referring to FIGS. 2A and 2B, the movable part 160 has an arch shape with an uneven outer surface. The movable part 160 is supported independently of the shaft 120. Specifically, the movable part 160 includes two arch-shaped members that each extend in the front-rear direction and are arranged with the bearing 180 interposed therebetween in the front-rear direction. The movable part 160 is supported by the intermediate bracket 150 in such a manner as to be slidable in the front-rear direction, with the shaft 120 extending through the openings of the two arch-shaped members. Specifically, as illustrated in FIG. 6, the movable part 160 is radially spaced apart from the outer periphery of the shaft 120. In this state, the movable part 160 is supported in such a manner as to be slidable in the front-rear direction on the intermediate bracket 150 but is restricted from moving in the top-bottom direction. The movable part 160 includes a main member 162, a handle 176, an assist member 178, and a returning member 170.

As illustrated in FIGS. 3, 4A, 4B, and 6, the main member 162 has an arch shape and is located on the front side of the movable part 160 in the front-rear direction. The main member 162 has on the inner side thereof an opening through which the shaft 120 is allowed to pass (see FIG. 6). The main member 162 is supported by the intermediate bracket 150 with the aid of a guiding member (not illustrated). The main member 162 is slidable on the intermediate bracket 150 in the front-rear direction while being restricted from moving in the top-bottom direction. The main member 162 is located on the front side relative to the intermediate spring 140 in the front-rear direction. When the movable part 160 is moved rearward in the front-rear direction, a tapered portion 166, to be described below, goes into the gap between the shaft 120 and the intermediate spring 140, thereby moving the intermediate spring 140 away from the shaft 120 (details will be described separately below).

As illustrated in FIGS. 4B and 6, the tapered portion 166 is provided at the upper surface of the main member 162 and is inclined from the front side toward the rear side in the front-rear direction. The tapered portion 166 is a portion of the main member 162. The tapered portion 166 has a distal end EG, which is located closer to the shaft 120 than the center CS of the intermediate spring 140. The main member 162 has a rear end face 166A, which is located on the rear side in the front-rear direction and is rounded. The distal end EG refers to the front-side endpoint of the rounded part in the front-rear direction. The length of the tapered portion 166 in the front-rear direction is longer than the diameter (twice the radius RS) of the intermediate spring 140. When the intermediate spring 140 is placed on the tapered portion 166, that is, when the position P1 of the bearing 180 is shifted from the position P0, the tapered portion 166 receives an urging force from the intermediate spring 140.

As illustrated in FIGS. 4A and 4B, the handle 176 is located at the front end of the main member 162 in the front-rear direction and has a flange shape projecting from the main member 162 in the top-bottom direction and in the widthwise direction. The handle 176 is a plate extending in the top-bottom direction and in the widthwise direction. The handle 176 is provided for the operator (not illustrated) to operate in moving the movable part 160 in the front-rear direction. The tapered portion 166 extends up to the handle 176. The movable part 160 is movable frontward in the front-rear direction until coming into contact with the front wall 151 of the intermediate bracket 150.

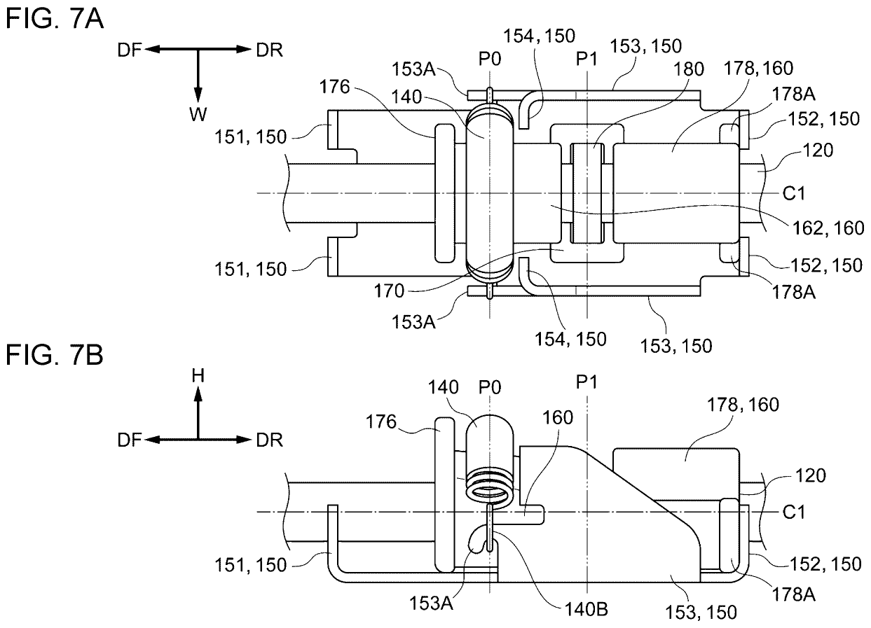

The assist member 178 has an arch shape. In the state, illustrated in FIG. 6, where the urging force of the intermediate spring 140 is effective, the assist member 178 is positioned such that the intermediate spring 140 is held between the main member 162 and the assist member 178 in the front-rear direction, with a distance DM provided between the main member 162 and the assist member 178. The assist member 178 has on the inner side thereof an opening through which the shaft 120 is allowed to pass. As illustrated in FIGS. 7A and 7B, the assist member 178 has a projection 178A at the rear end thereof in the front-rear direction. The projection 178A exerts a stopper function of stopping the movement of the movable part 160 in the front-rear direction, by coming into contact with the rear wall 152 of the intermediate bracket 150. The distance DM between the assist member 178 and the main member 162 is longer than twice the radius RS of the intermediate spring 140 (i.e., than the diameter of the intermediate spring 140).

As illustrated in FIG. 5, the returning member 170 is located between the main member 162 and the assist member 178 and connects the main member 162 and the assist member 178 to each other. In the present exemplary embodiment, the returning member 170, the main member 162, and the assist member 178 are integrated with each other.

The returning member 170 is recessed in the widthwise direction on a side thereof that faces the shaft 120. Specifically, the returning member 170 is shaped such that two end portions thereof in the front-rear direction project toward the shaft 120 relative to a central portion thereof in the front-rear direction, and the bearing 180 is held between the two end portions. That is, the returning member 170 included in the movable part 160 causes the bearing 180 to move in the front-rear direction by moving in the front-rear direction. Specifically, when the bearing 180 comes into contact with the rear one of the end portions of the returning member 170 in the front-rear direction, the bearing 180 is moved frontward in the front-rear direction. On the other hand, when the bearing 180 comes into contact with the front one of the end portions of the returning member 170 in the front-rear direction, the bearing 180 is moved rearward in the front-rear direction.

Thus, the nipping-pressure-adjusting mechanism 100 adjusts the nipping pressure to be applied to the transport-roll pairs 130, in correspondence with the position of the movable part 160, or the bearing 180.

Then, the image forming apparatus 10 transfers the set of toner images formed by the main operation section 14 to the sheet member P transported from the sheet container section 12 through the transport section 18.

### Operational Effects

Operational effects produced by the transport device 38 according to the present exemplary embodiment will now be described. As illustrated in FIGS. 4A and 4B, when the position P1 coincides with the position P0, the bearing 180 receives, at the outer peripheral surface thereof, an urging force from the intermediate spring 140. When the bearing 180 receives the urging force, a nipping pressure is applied to the transport-roll pairs 130 through the shaft 120. In this state, since the intermediate spring 140 has a greater elastic modulus than the end-side springs 190, the nipping pressure is greater than in a case where the nipping pressure is applied to the transport-roll pairs 130 only by using the end-side springs 190.

Now, how to adjust the nipping pressure will be described. To change the nipping pressure, the operator grips the handle 176 of the movable part 160 and moves the movable part 160, altogether with the bearing 180, rearward in the front-rear direction. As illustrated in FIGS. 7A and 7B, when the position P1 is shifted from the position P0, that is, when the position P1 is on the rear side relative to the position P0 in the front-rear direction, the bearing 180 is free from the urging force of the intermediate spring 140. Instead, the movable part 160, more specifically the tapered portion 166, receives the urging force. When the position P1 is shifted from the position P0, the intermediate spring 140 moves toward the handle 176 along the tapered portion 166 of the movable part 160. When the assist member 178 of the movable part 160 comes into contact with the intermediate bracket 150, the movable part 160 stops moving in the front-rear direction.

The transport device 38 according to the present exemplary embodiment includes the shaft 120 provided with the transport-roll pairs 130 configured to transport the sheet member P, the shaft 120 extending in the front-rear direction intersecting the transport direction CV and being rotatably supported; the intermediate spring 140 configured to apply a nipping pressure to the transport-roll pairs 130 by urging the shaft 120 from the outer peripheral side of the shaft 120; and the movable part 160 supported independently of the shaft 120 and configured to move the intermediate spring 140 away from the shaft 120 by moving in the front-rear direction in such a manner as to go into a gap between the shaft 120 and the intermediate spring 140.

The transport device 38 according to the present exemplary embodiment further includes the bearing 180 provided on the outer peripheral side of the shaft 120 and being movable from the position P1 to the position P0 with the movement of the movable part 160. The position P1 is a position where the bearing 180 transmits the urging force of the intermediate spring 140 to the shaft 120. The position P0 is a position that is shifted from the position P1 in the front-rear direction and where the bearing 180 is free from the urging force.

In the transport device 38 according to the present exemplary embodiment, the movable part 160 includes the tapered portion 166 that is inclined toward the bearing 180 and that is to receive the urging force.

In the transport device 38 according to the present exemplary embodiment, the intermediate spring 140 has a circular sectional shape and is positioned such that he central portion 140C is in contact with the bearing 180 with the two ends 140A and 140B being supported at the respective locations across the shaft 120 from each other in the transport direction CV. Furthermore, when the bearing 180 is at the position P1, the distal end EG of the tapered portion 166 is located closer to the shaft 120 than the center CS of the central portion 140C.

In the transport device 38 according to the present exemplary embodiment, the movable part 160 includes the returning member 170 located apart from the bearing 180 in the front-rear direction and projecting toward the shaft 120. The returning member 170 is configured to move the bearing 180 along with the movable part 160 in the front-rear direction. In such a configuration, when the movable part 160 is moved rearward in the front-rear direction, the bearing 180 is moved rearward in the front-rear direction.

In the transport device 38 according to the present exemplary embodiment, the movable part 160 includes the handle 176 provided for the operator to operate in moving the movable part 160 in the front-rear direction.

The image forming apparatus 10 according to the present exemplary embodiment includes the transport section 18 including the transport device 38 described above, and the main operation section 14 configured to form an image on a sheet member P transported by the transport section 18.

### Modifications

While the present disclosure has been described in detail by taking a specific exemplary embodiment, the present disclosure is not limited to the above exemplary embodiment. It is apparent to those skilled in the art that the present disclosure can be embodied in various other ways within the scope of the present disclosure.

While the above image forming apparatus 10 is an electrophotographic apparatus, the image forming apparatus 10 is not limited thereto. The image forming apparatus 10 may be an inkjet apparatus.

While the above intermediate spring 140 is supported by the intermediate bracket 150, the intermediate spring 140 is not limited thereto. The intermediate spring 140 may be supported by the apparatus body 10a with the aid of the intermediate bracket 150, or may be directly supported by the apparatus body 10a. Furthermore, the intermediate spring 140 may be a helical compression spring or a leaf spring.

The transport device 38 according to the above exemplary embodiment includes the bearing 180 provided on the outer peripheral side of the shaft 120 and being movable from the position P1 to the position P0 with the movement of the movable part 160. The position P1 is a position where the bearing 180 transmits the urging force of the intermediate spring 140 to the shaft 120. The position P0 is a position that is shifted from the position P1 in the front-rear direction and where the bearing 180 is free from the urging force. Such a bearing 180 is not essential. The bearing 180 may be a slide bearing. Moreover, the bearing 180 may be omitted. Instead, the intermediate spring 140 may directly urge the shaft 120.

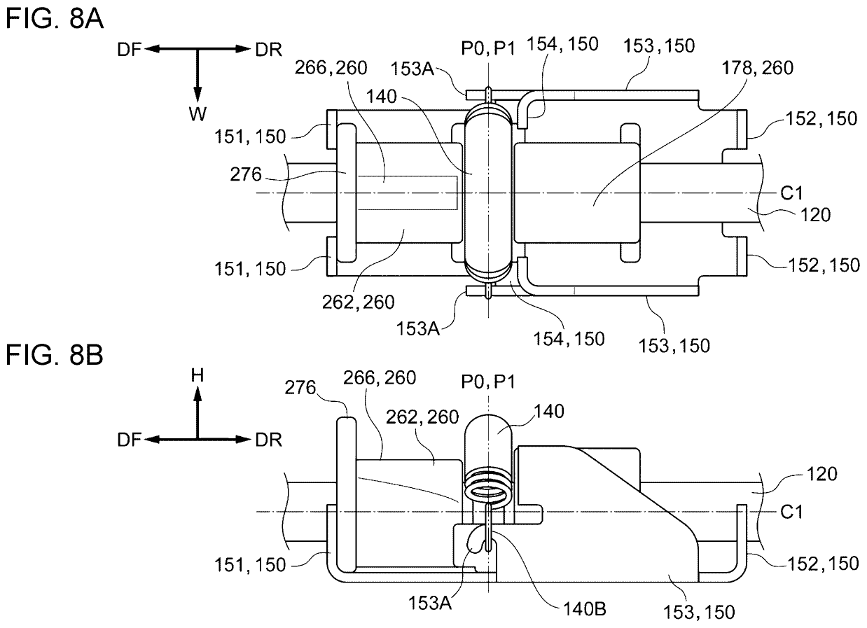

While the movable part 160 according to the above exemplary embodiment includes the tapered portion 166 provided at the upper surface thereof, the movable part is not limited thereto. For example, as illustrated in FIGS. 8A and 8B, a movable part 260 may be employed, in which a flat portion 266 extends flat in the front-rear direction at the upper surface of the movable part 260. In such a case, when the operator (not illustrated) operates a handle 276, the flat portion 266 receives a constant urging force from the intermediate spring 140. Alternatively, both the tapered portion and the flat portion may be provided at the upper surface of the movable part. Note that the elements of such a modification other than the movable part 260 are the same as the basic elements employed in the above exemplary embodiment.

In the transport device 38 according to the above exemplary embodiment, the intermediate spring 140 has a circular sectional shape and is positioned such that the central portion 140C is in contact with the bearing 180 with the two ends 140A and 140B being supported at the respective locations across the shaft 120 from each other in the transport direction CV. Furthermore, when the bearing 180 is at the position P1, the distal end EG of the tapered portion 166 is located closer to the shaft 120 than the center CS of the central portion 140C. Such an intermediate spring 140 is not essential. The intermediate spring 140 may have a rectangular sectional shape, as long as the intermediate spring 140 is able to urge the bearing 180 and the movable part 160.

In the transport device 38 according to the above exemplary embodiment, the movable part 160 includes the returning member 170 located apart from the bearing 180 in the front-rear direction and projecting toward the shaft 120. The returning member 170 is configured to move the bearing 180 along with the movable part 160 frontward in the front-rear direction. Such a movable part 160 is not essential. For example, the movable part 160 and the returning member 170 may be separate from each other.

In the transport device 38 according to the above exemplary embodiment, while the movable part 160 includes the handle 176 provided for the operator to operate in moving the movable part 160 in the front-rear direction, the movable part 160 is not limited thereto. For example, the movable part 160 and the handle 176 may be separate from each other.

While the image forming apparatus 10 according to the above exemplary embodiment includes the transport section 18 including the transport device 38 described above; and the main operation section 14 configured to form an image on a sheet member P transported by the transport section 18, the image forming apparatus 10 is not limited thereto. The present disclosure may be applied to an apparatus constituted by a sheet feeding device and the transport device, or an apparatus constituted by a post-processing device, such as a bookbinder or a sheet folder, and the transport device.

### APPENDIX

(((1)))

A transport device comprising:
a shaft body provided with a transport member configured to transport a medium, the shaft body extending in a first direction intersecting a transport direction in which the medium is to be transported, the shaft body being rotatably supported;
an urging part configured to apply a nipping pressure to the transport member by urging the shaft body from an outer peripheral side of the shaft body; and
a movable part supported independently of the shaft body and configured to move the urging part away from the shaft body by moving in the first direction in such a manner as to go into a gap between the shaft body and the urging part.
   (((2)))

The transport device according to (((1))), further comprising:
a receiving part provided on the outer peripheral side of the shaft body and being movable from a first position to a second position with a movement of the movable part, the first position being a position where the receiving part transmits an urging force of the urging part to the shaft body, the second position being a position that is shifted from the first position in the first direction and where the receiving part is free from the urging force.
   (((3)))

The transport device according to (((2))),
wherein the movable part includes a tapered portion that is inclined toward the receiving part and that is to receive the urging force.
   (((4)))

The transport device according to (((3))),
wherein the urging part has a circular sectional shape and is positioned such that a central portion of the urging part is in contact with the receiving part with two ends of the urging part being supported at respective locations across the shaft body from each other in the transport direction, and
wherein when the receiving part is at the first position, a distal end of the tapered portion is located closer to the shaft body than a center of the central portion.
   (((5)))

The transport device according to any of (((2))) to (((4))),
wherein the movable part includes a returning member located apart from the receiving part in the first direction and projecting toward the shaft body, the returning member being configured to move the receiving part along with the movable part in an opposite direction that is opposite to the first direction.
   (((6)))

The transport device according to any of (((2))) to (((5))),
wherein the movable part includes a handle provided for an operator to operate in moving the movable part in the first direction or the opposite direction.
   (((7)))

An image forming apparatus comprising:
the transport device according to any of (((1))) to (((6))); and
an image forming unit configured to form an image on the medium transported by the transport device.

What is claimed is:

1. A transport device comprising:
a shaft body provided with a transport member configured to transport a medium, the shaft body extending in a first direction intersecting a transport direction in which the medium is to be transported, the shaft body being rotatably supported;
an urging part configured to apply a nipping pressure to the transport member by urging the shaft body from an outer peripheral side of the shaft body; and
a movable part supported independently of the shaft body and configured to move the urging part away from the shaft body by moving in the first direction in such a manner as to go into a gap between the shaft body and the urging part.

2. The transport device according to claim 1, further comprising:
a receiving part provided on the outer peripheral side of the shaft body and being movable from a first position to a second position with a movement of the movable part, the first position being a position where the receiving part transmits an urging force of the urging part to the shaft body, the second position being a position that is shifted from the first position in the first direction and where the receiving part is free from the urging force.

3. The transport device according to claim 2,
wherein the movable part includes a tapered portion that is inclined toward the receiving part and that is to receive the urging force.

4. The transport device according to claim 3,
wherein the urging part has a circular sectional shape and is positioned such that a central portion of the urging part is in contact with the receiving part with two ends of the urging part being supported at respective locations across the shaft body from each other in the transport direction, and
wherein when the receiving part is at the first position, a distal end of the tapered portion is located closer to the shaft body than a center of the central portion.

5. The transport device according to claim 2,
wherein the movable part includes a returning member located apart from the receiving part in the first direction and projecting toward the shaft body, the returning member being configured to move the receiving part along with the movable part in an opposite direction that is opposite to the first direction.

6. The transport device according to claim 5,
wherein the movable part includes a handle provided for an operator to operate in moving the movable part in the first direction or the opposite direction.

7. An image forming apparatus comprising:
the transport device according to claim 1; and
an image forming unit configured to form an image on the medium transported by the transport device.

8. An image forming apparatus comprising:
the transport device according to claim 2; and
an image forming unit configured to form an image on the medium transported by the transport device.

9. An image forming apparatus comprising:
the transport device according to claim 3; and
an image forming unit configured to form an image on the medium transported by the transport device.

10. An image forming apparatus comprising:
the transport device according to claim 4; and
an image forming unit configured to form an image on the medium transported by the transport device.

11. An image forming apparatus comprising:
the transport device according to claim 5; and
an image forming unit configured to form an image on the medium transported by the transport device.

12. An image forming apparatus comprising:
the transport device according to claim 6; and
an image forming unit configured to form an image on the medium transported by the transport device.
